(19) United States
(12) Patent Application Publication
(10) Pub. No.: US 2026/0154687 A1
(43) Pub. Date: Jun. 4, 2026

(54) METHOD AND SYSTEM TO DETERMINE AUTHENTICITY OF A CHECK

(71) Applicant: JPMorgan Chase Bank, N.A., New York, NY (US)

(72) Inventors: Varun JETHWANI, Hyderabad (IN); Prabhat SAMUEL, Hyderabad (IN); Pinky CHOUDHARY, Hyderabad (IN)

(73) Assignee: JPMorgan Chase Bank, N.A., New York, NY (US)

(21) Appl. No.: 19/020,742

(22) Filed: Jan. 14, 2025

(30) Foreign Application Priority Data
Nov. 29, 2024 (IN) 202411093850

(51) Int. Cl. G06Q 20/40; G06Q 20/04; G06Q 40/02; G06V 10/74; G06V 10/75; G06V 30/19; G06V 30/418; G06V 30/42

(52) U.S. Cl. CPC G06Q 20/4016; G06Q 20/042; G06Q 40/02; G06V 10/751; G06V 10/761; G06V 30/19013; G06V 30/19093; G06V 30/418; G06V 30/42

(57) ABSTRACT

A method and system to determine an authenticity of a check are disclosed. The method includes receiving a first image of a check and extracting a first set of parameters associated with the first image of the check. Next, the method includes receiving a second image of the check subsequent to a deposit of the check and extracting a second set of parameters associated with the second image of the check. Next, the method includes comparing the first set of parameters with the second set of parameters to determine an overlap between the the two sets of parameters. Next, the method includes generating a check similarity score based on the determined overlap. Thereafter, the method includes determining an authenticity of the check based on a comparison of the check similarity score with a predefined threshold validity score.

### CROSS-REFERENCE TO RELATED APPLICATIONS

This application claims priority benefit from Indian Application No. 202411093850, filed on Nov. 29, 2024 in the India Patent Office, which is hereby incorporated by reference in its entirety.

### FIELD OF THE DISCLOSURE

This technology generally relates to image processing, and more particularly relates to a method and system to determine authenticity of a check using image processing techniques.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In the last few decades, banking transactions offered by banking services have reached a large chunk of society in most of the nations across the globe. A financial transaction or a bank transaction is any interaction that takes place between a customer and a bank or a financial institution. Without the ability to deposit, withdraw, and transfer funds, the modern economy would not function, hence bank transactions are necessary for the functioning of the modern economy. The bank transactions provide a record of money moving in and out of accounts. Analyzing such bank transactions is key for both customers and businesses to track finances and avoid financial frauds. Types of bank transactions may include but are not limited to cash withdrawals or deposits, check (also referred to as cheque) payments, online payments, card payments, and loan payments. A bank check is one of the popular ways to perform cashless transactions. A bank check is a written, dated, and signed draft to indicate to a bank to pay a definite sum of money to a payee.

In recent years, check fraud has remained a big worry for banks, as thieves/fraudsters have focused their attention on bank checks. Check fraud is a common form of financial crime, and most common types of bank check fraud include fake checks, forgery (e.g., when stolen checks are signed by someone other than the account holders), and altered checks (e.g., when checks are issued by the account holders and altered to change a beneficiary or amount).

A major problem that banks face is determining the legitimacy of deposited checks. Because fraudsters often change their strategies, the banks may find it difficult to confirm authenticity of the checks and frequently encounter barriers when attempting to get in touch with the real issuer of the checks. Not only do banks suffer enormous financial losses as a result, but it also frustrates customers (payers or payee) when legitimate checks are needlessly held up by overzealous fraud detection systems. With an increase in the number of check related frauds, there is a need for the banks to employ an intelligent technology to protect their customers and themselves against various types of check fraud.

Hence, in view of these and other existing limitations, there arises an imperative need to provide an efficient solution to overcome the above-mentioned limitations and to provide a method and system to efficiently and reliably determine the authenticity of the check.

### SUMMARY

The present disclosure, through one or more of its various aspects, embodiments, and/or specific features or sub-components, provides, inter alias, various systems, servers, devices, methods, media, programs, and platforms to determine an authenticity of a check.

According to an aspect of the present disclosure, a method for determining an authenticity of a check is disclosed. The method is implemented by at least one processor. The method includes receiving, by the at least one processor, a first image of a check. Next, the method includes extracting, by the at least one processor, a first set of parameters associated with the first image of the check. Next, the method includes storing, by the at least one processor, the first set of parameters in a database. Next, the method includes receiving, by the at least one processor, a second image of the check subsequent to a deposit of the check, via at least one deposit channel. Next, the method includes extracting, by the at least one processor, a second set of parameters associated with the second image of the check. Next, the method includes comparing, by the at least one processor, the first set of parameters with the second set of parameters to determine an overlap between the first set of parameters and the second set of parameters. Next, the method includes generating, by the at least one processor, a check similarity score based on the determined overlap between the first set of parameters and the second set of parameters. Next, the method includes determining, by the at least one processor, an authenticity of the check based on a comparison of the generated check similarity score with a predefined threshold validity score.

In accordance with an exemplary embodiment, the first image of the check is received from a payer of the check and the second image of the check is received from a financial institution associated with processing of the deposited check.

In accordance with an exemplary embodiment, the first set of parameters is extracted by applying at least one image processing algorithm to the first image of the check, and the second set of parameters is extracted by applying the at least one image processing algorithm to the second image of the check.

In accordance with an exemplary embodiment, each of the first set of parameters and the second set of parameters includes at least one from among a name of a payer, a name of a payee, a name of an issuing bank, branch details, an account number of the payer, a magnetic ink character recognition (MICR) code, a date, a signature, a check number, and an amount.

In accordance with an exemplary embodiment, the generating of the check similarity score is further based on a result of a pixel-by-pixel comparison between the first image of the check and the second image of the check.

In accordance with an exemplary embodiment, the authenticity of the check is determined as a valid check in an event the generated check similarity score is at least equal or greater than the predefined threshold validity score.

In accordance with an exemplary embodiment, the authenticity of the check is determined as a fraudulent check in an event the generated check similarity score is less than the predefined threshold validity score.

In accordance with an exemplary embodiment, the method may further include displaying, by the at least one processor via an interface that is accessible by a financial institution, the generated check similarity score and at least one reason associated with the generated check similarity score. Next, the method may further include receiving, by the at least one processor, a feedback from the financial institution in response to the displayed check similarity score.

In accordance with an exemplary embodiment, the method may further include providing, by the at least one processor, the received feedback to a trained model to improve future check evaluations related to the check similarity score.

According to another aspect of the present disclosure, a computing device configured to implement an execution of a method to determine an authenticity of a check is disclosed. The computing device includes a processor; a memory; and a communication interface coupled to each of the processor and the memory. The processor may be configured to receive a first image of a check. Next, the processor may be configured to extract a first set of parameters associated with the first image of the check. Next, the processor may be configured to store the first set of parameters in a database. Next, the processor may be configured to receive a second image of the check subsequent to a deposit of the check, via at least one deposit channel. Next, the processor may be configured to extract a second set of parameters associated with the second image of the check. Next, the processor may be configured to compare the first set of parameters with the second set of parameters to determine an overlap between the first set of parameters and the second set of parameters. Next, the processor may be configured to generate a check similarity score based on the determined overlap between the first set of parameters and the second set of parameters. Next, the processor may be configured to determine an authenticity of the check based on a comparison of the generated check similarity score with a predefined threshold validity score.

In accordance with an exemplary embodiment, the first image of the check is received from a payer of the check, and the second image of the check is received from a financial institution associated with processing of the deposited check.

In accordance with an exemplary embodiment, the first set of parameters is extracted by applying at least one image processing algorithm to the first image of the check, and the second set of parameters is extracted by applying the at least one image processing algorithm to the second image of the check.

In accordance with an exemplary embodiment, each of the first set of parameters and the second set of parameters includes at least one from among a name of a payer, a name of a payee, a name of an issuing bank, branch details, an account number of the payer, a magnetic ink character recognition (MICR) code, a date, a signature, a check number, and an amount.

In accordance with an exemplary embodiment, the generation of the check similarity score is further based on a result of a pixel-by-pixel comparison between the first image of the check and the second image of the check.

In accordance with an exemplary embodiment, the authenticity of the check is determined as a valid check in an event the generated check similarity score is at least equal or greater than the predefined threshold validity score.

In accordance with an exemplary embodiment, the authenticity of the check is determined as a fraudulent check in an event the generated check similarity score is less than the predefined threshold validity score.

In accordance with an exemplary embodiment, the processor may be further configured to display, via an interface that is accessible by a financial institution, the generated check similarity score and at least one reason associated with the generated check similarity score. Next, the processor may be further configured to receive a feedback from the financial institution in response to the displayed check similarity score.

In accordance with an exemplary embodiment, the processor may be further configured to provide the received feedback to a trained model to improve future check evaluations related to the check similarity score.

According to yet another aspect of the present disclosure, a non-transitory computer-readable storage medium storing instructions to determine an authenticity of a check is disclosed. The instructions include executable code which, when executed by a processor, may cause the processor to receive a first image of a check; extract a first set of parameters associated with the first image of the check; store the first set of parameters in a database; receive a second image of the check subsequent to a deposit of the check, via at least one deposit channel; extract a second set of parameters associated with the second image of the check; compare the first set of parameters with the second set of parameters to determine an overlap between the first set of parameters and the second set of parameters; generate a check similarity score based on the determined overlap between the first set of parameters and the second set of parameters; and determine an authenticity of the check based on a comparison of the generated check similarity score with a predefined threshold validity score.

In accordance with an exemplary embodiment, the first image of the check is received from a payer of the check and the second image of the check is received from a financial institution associated with processing of the deposited check.

In accordance with an exemplary embodiment, the first set of parameters is extracted by applying at least one image processing algorithm to the first image of the check, and the second set of parameters is extracted by applying the at least one image processing algorithm to the second image of the check.

In accordance with an exemplary embodiment, each of the first set of parameters and the second set of parameters includes at least one from among a name of a payer, a name of a payee, a name of an issuing bank, branch details, an account number of the payer, a magnetic ink character recognition (MICR) code, a date, a signature, a check number, and an amount.

In accordance with an exemplary embodiment, wherein the generation of the check similarity score is further based on a result of a pixel-by-pixel comparison between the first image of the check and the second image of the check.

In accordance with an exemplary embodiment, the authenticity of the check is determined as a valid check in an event the generated check similarity score is at least equal or greater than the predefined threshold validity score.

In accordance with an exemplary embodiment, the authenticity of the check is determined as a fraudulent check in an event the generated check similarity score is less than the predefined threshold validity score.

In accordance with an exemplary embodiment, the executable code when executed may further cause the processor to display, via an interface that is accessible by a financial institution, the generated check similarity score and at least one reason associated with the generated check similarity score; and receive a feedback from the financial institution in response to the displayed check similarity score.

In accordance with an exemplary embodiment, the executable code when executed may further cause the processor to provide the received feedback to a trained model to improve future check evaluations related to the check similarity score.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system to determine an authenticity of a check, in accordance with an exemplary embodiment of the present disclosure.

FIG. 2 illustrates an exemplary diagram of a network environment to determine an authenticity of a check, in accordance with an exemplary embodiment of the present disclosure.

FIG. 3 illustrates an exemplary system to determine an authenticity of a check, in accordance with an exemplary embodiment of the present disclosure.

FIG. 4 illustrates an exemplary method flow diagram to determine an authenticity of a check, in accordance with an exemplary embodiment of the present disclosure.

FIG. 5 illustrates a process flow diagram representing a transaction of an issued check, in accordance with an exemplary embodiment of the present disclosure.

FIG. 6 illustrates a process flow diagram representing an image analysis process of a check image, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system to determine an authenticity of a check. More particularly, banks often face problems (such as counterfeit checks or fake checks) in determining the legitimacy of deposited checks. Hence, banks and customers or account holders may suffer from financial losses due to fraudulent financial transactions.

The present disclosure solves aforementioned problems by providing a method and system to determine an authenticity of the check by comparing textual information and image statistics of a maker's check and its corresponding deposited check and providing a recommendation about whether or not the deposited check is valid based on the comparison. In the present disclosure, at first, the system receives a first image of the check. Further, the system extracts a first set of parameters associated with the first image of the check. Further, the system stores the first set of parameters in a database. Further, the system receives a second image of the check subsequent to a deposit of the check, via at least one deposit channel. Further, the system extracts a second set of parameters associated with the second image of the check. Further, the system compares the first set of parameters with the second set of parameters to determine an overlap between the first set of parameters and the second set of parameters. Further, the system generates a check similarity score based on the determined overlap between the first set of parameters and the second set of parameters. Further, the system determines the authenticity of the check based on a comparison of the generated check similarity score with a predefined threshold validity score. This way the system detects check fraud and performs validation of checks deposited with the bank.

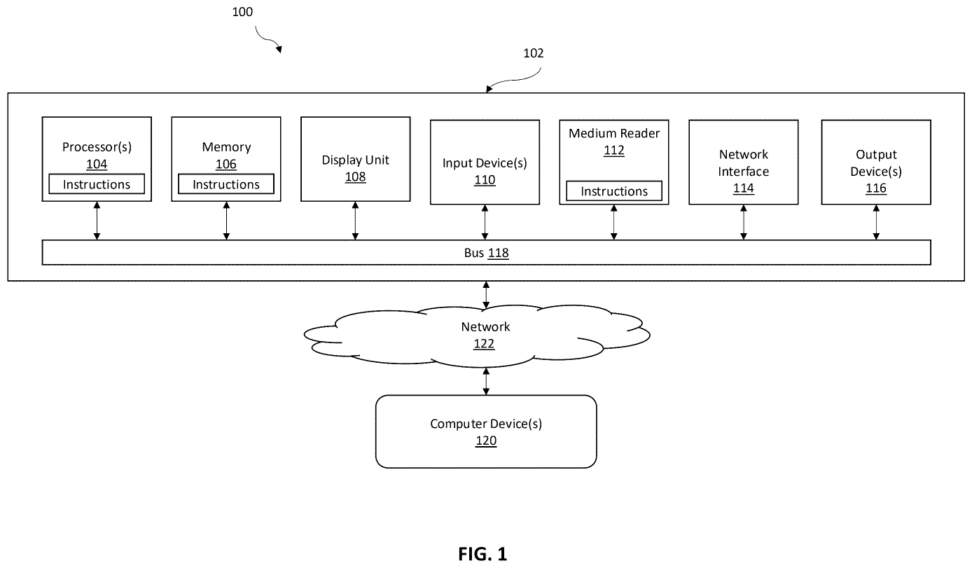

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to determine an authenticity of a check.

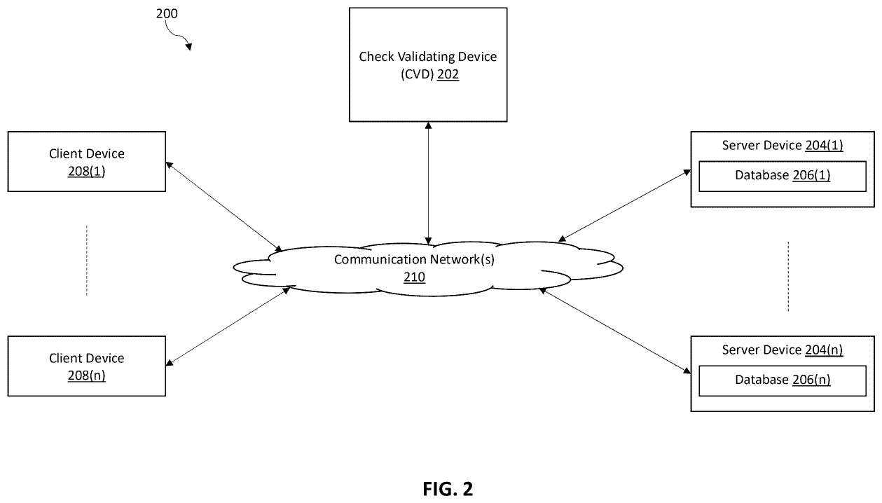

Referring to FIG. 2, a schematic of an exemplary network environment 200 to determine an authenticity of a check is illustrated. In an exemplary embodiment, the method is executable on any networked computer platform, such as, for example, a personal computer (PC).

The method to determine an authenticity of a check may be executed by a check validating device (CVD) 202. The CVD 202 may be the same or similar to the computer system 102 as described with respect to FIG. 1. The CVD 202 may store one or more applications that may include executable instructions that, when executed by the CVD 202, cause the CVD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the CVD 202 itself, may be located in the virtual server(s) running in a cloud-based computing environment rather than being tied to one or more specific physical network computing devices. Also, the application(s) may be running in one or more virtual machines (VMs) executing on the CVD 202. Additionally, in one or more embodiments of this technology, virtual machine(s) running on the CVD 202 may be managed or supervised by a hypervisor.

In the network environment 200 of FIG. 2, the CVD 202 is coupled to a plurality of server devices 204(1)-204(n) that hosts a plurality of databases 206(1)-206(n), and also to a plurality of client devices 208(1)-208(n) via communication network(s) 210. A communication interface of the CVD 202, such as the network interface 114 of the computer system 102 of FIG. 1, operatively couples and communicates between the CVD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CVD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and CVDs that efficiently implement the method to determine an authenticity of a check.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The CVD 202 may be a standalone device or integrated with one or more other devices or apparatuses, such as one or more of the server devices 204(1)-204(n), for example. In one particular example, the CVD 202 may include or be hosted by one of the server devices 204(1)-204(n), and other arrangements are also possible. Moreover, one or more of the devices of the CVD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the CVD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a plurality of recommendations and a plurality of parameters associated with checks submitted to a financial institution, such as bank.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CVD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the CVD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the CVD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CVD 202, the server devices 204(1)-204(n), or the client devices 208(1)-208(n), for example, may be configured to operate as virtual instances on the same physical machine. In other words, one or more of the CVD 202, the server devices 204(1)-204(n), or the client devices 208(1)-208(n) may operate on the same physical device rather than as separate devices communicating through communication network(s) 210. Additionally, there may be more or fewer CVDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

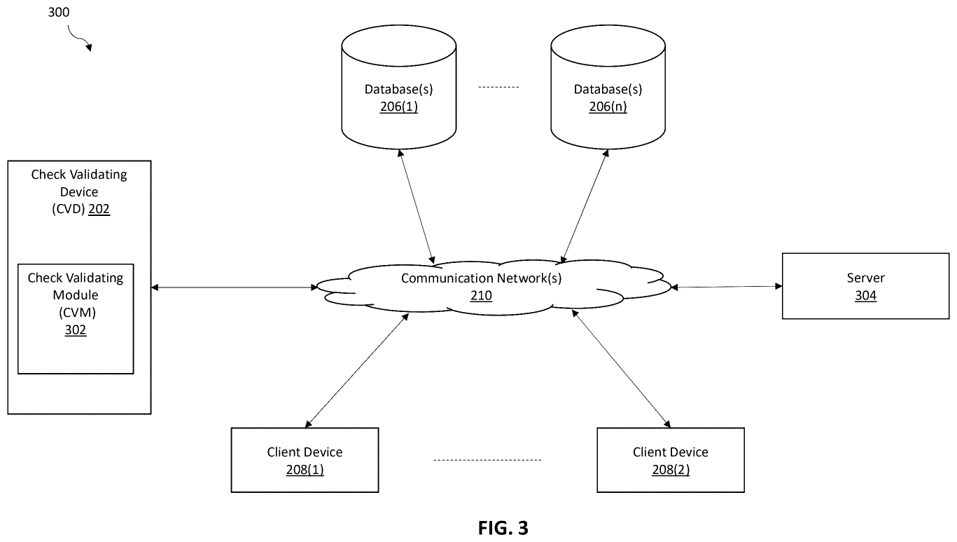

FIG. 3 illustrates a system diagram for implementing a method for determining an authenticity of a check, in accordance with an exemplary embodiment.

As illustrated in FIG. 3, the system 300 may include a check validating device (CVD) 202 within which a check validating module (CVM) 302 is embedded, a server 304, a database(s) 206(1) . . . 206(n), a plurality of client devices 208(1) . . . 208(2), and a communication network(s) 210.

According to exemplary embodiments, the system 300 may comprise the check validating device (CVD) 202 including the CVM 302, which may be connected to the server 304 and the database(s) 206(1) . . . 206(n) via the communication network(s) 210, but the disclosure is not limited thereto. The CVD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the CVD 202 is described and shown in FIG. 3 as including the CVM 302, although it may include other rules, policies, modules, databases, or applications, for example. As will be described below, the CVM 302 is configured to carry out a method for determining an authenticity of a check.

An exemplary system 300 for enabling a mechanism for determining an authenticity of a check by utilizing the network environment of FIG. 2 is shown as being executed in FIG. 3. Specifically, a first client device 208(1) and a second client device 208(2) are illustrated as being in communication with CVD 202. In this regard, the first client device 208(1) and the second client device 208(2) may be “clients” of the CVD 202 and are described herein as such. Nevertheless, it is to be known and understood that the first client device 208(1) and/or the second client device 208(2) need not necessarily be “clients” of the CVD 202, or any entity described in association therewith herein. Any additional or alternative relationship may exist between either or both of the first client device 208(1) and the second client device 208(2) and the CVD 202, or no relationship may exist.

Further, the CVD 202 is illustrated as being able to access one or more database(s) 206(1) . . . 206(n). The CVM 302 may be configured to access these repositories/databases to provide a method for determining an authenticity of a check. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the CVD 202 via broadband or cellular communication. These embodiments are merely exemplary and are not limiting or exhaustive.

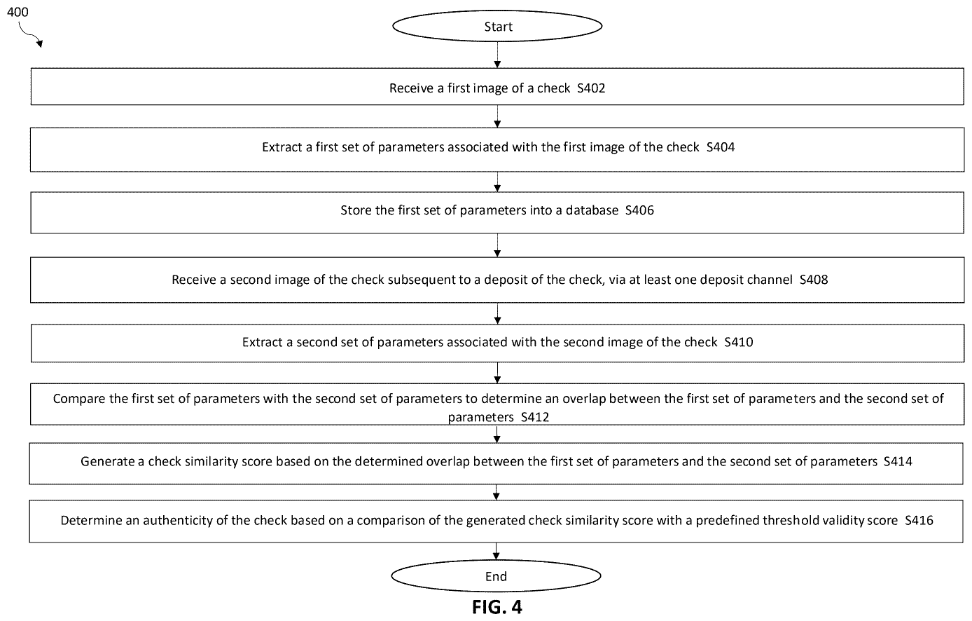

Referring to FIG. 4, an exemplary method 400 is shown for determining an authenticity of a check, in accordance with an exemplary embodiment. In particular, the exemplary method 400 is shown for determining an authenticity of a check.

As shown in FIG. 4, the method 400 begins following a need to detect whether an information on a check has been improperly modified after the original preparation of the check for determining the authenticity of the check. The method 400 is implemented by at least one processor 104.

At step S402, the method 400 includes receiving, by the at least one processor 104, a first image of a check (also referred to as cheque). The first image of the check is received from a payer of the check.

The term “check” herein may correspond to a written, dated, and signed instrument that directs a bank to pay a specific amount of money from a drawer's or a payer's (e.g., a person who writes the check) account to a payee (e.g., the person or an entity to whom the check is written). There are several types of checks that banks issue. Examples of checks are provided as follows: a certified check, a cashier check, a counter check, a retail individual check, or a business check.

For example, a retail customer or a payer may capture and upload a first image of a check via an application (e.g., a mobile banking application of a bank) or a website. The uploaded image of the check is then received by the at least one processor 104 for processing of the image. The term “application” herein may correspond to a software program or tool that is designed to perform specific tasks or functions for the user. Thus, the image of the payer check is received by the bank through a digital channel such as but not limited to mobile applications owned by the financial institutions.

In an exemplary implementation, the method includes fetching, by the at least one processor 104, the first image of the check from at least one external source. The at least one external source may be selected from but not limited to, a server, a cloud server, and at least one database. The database may be connected with the at least one processor 104 via a network. The network may be an Internet-based network. The at least one external source may be connected with the application or the website which the payer might be using to upload the first image of the check for further processing by a financial transaction such as the bank.

In an exemplary implementation, the first image of the check may be fetched using secure data communication protocols to ensure the integrity and confidentiality of the first image of the check.

It will be appreciated by the person skilled in the art that the aim here is to create a system that provides recommendation(s) about a legitimacy of the check and performs validation of the check to determine the authenticity of the check.

At step S404, the method includes extracting, by the at least one processor 104, a first set of parameters associated with the first image of the check. The first set of parameters may include at least one from among a name of a payer, a name of a payee, a name of an issuing bank, branch details, an account number of the payer, a magnetic ink character recognition (MICR) code, a date, a signature, a check number, and an amount.

The term “parameters” herein may correspond to specific attributes or characteristics extracted from the first image of the check.

The term “MICR code” herein may correspond to a code that allows computers to read and process printed information through special characters printed with a magnetic ink. The MICR code typically appears at the bottom of checks and other negotiable instruments.

The first set of parameters is extracted by applying one or more image processing algorithms to the first image of the check. In an exemplary implementation, the method includes extracting, by the at least one processor 104 using the image processing algorithms, textual information and partitioning the first image of the check into a plurality of fields to identify image statistics of the first image. The image processing algorithms may include but are not limited to an optical character recognition (OCR) (also referred to as an OCR reading service) and structural similarity algorithms.

As used herein, the OCR is a technology that enables the recognition and extraction of text from images, such as scanned documents or photographs. Structural similarity algorithms compare the structural similarities between images or portions of images. In the context of check image validation, structural similarity algorithms assess the likeness or consistency of features within the check image. Structural similarity algorithms may detect alterations, forgeries, or inconsistencies in the check images by comparing various attributes such as textures, patterns, and spatial arrangements.

At step S406, the method includes storing, by the at least one processor 104, the first set of parameters in a database.

In an exemplary implementation, the first image of the check and the first set of parameters are stored in a bulk storage, such as the database, by the at least one processor 104 after performing sanitary checks and extracting key information from the first image of the check. The database may act as a central repository for the bank where checks are archived.

At step S408, the method includes receiving, by the at least one processor 104, a second image (e.g., an image of a deposited check corresponding to the first image of the check) of the check subsequent to a deposit of the check, via at least one deposit channel. The second image of the check is received from a financial institution (e.g., a bank) associated with processing the deposited check. The at least one deposit channel may include any one or more of an automated teller machine (ATM), a drive-through window, a quick deposit or a bank teller. The at least one deposit channel helps the payee to deposit the check to the bank. In another exemplary implementation, the second image of the check may also be received either from the depositor through a digital channel (such as through a bank application installed in the user device of the depositor) or from other financial institutions handling the check of the depositor. After receiving the check from the payee, the financial institution captures and uploads an image of the check at the mobile application or website associated with the financial institution to validate the authenticity of the check.

At step S410, the method includes extracting, by the at least one processor 104, a second set of parameters associated with the second image of the check. The second set of parameters associated with the second image includes at least one from among a name of a payer, a name of a payee, a name of an issuing bank, branch details, an account number of the payer, a magnetic ink character recognition (MICR) code, a date, a signature, a check number, and an amount. The second set of parameters are extracted by applying the image processing algorithms to the second image of the check.

In an exemplary implementation, the method includes partitioning, by the at least one processor 104 using the image processing algorithms, the second image of the check into the plurality of fields to identify image statistics of the second image.

For example, when the payee deposits the check in the bank (or the deposited check is scanned by bank officials and converted into an image file), the at least one processor 104 receives the second image of the check and further extracts the second set of parameters from the second image.

At step S412, the method includes comparing, by the at least one processor 104, the first set of parameters with the second set of parameters to determine an overlap between the first set of parameters and the second set of parameters.

It is to be noted that the comparison of the first set of parameters with the second set of parameters helps in identifying similarities, differences, additions, deletions, altering, or modifications made to the check after receiving it from the payer and thus helps in determining the legitimacy of the check. In an exemplary implementation, the at least one processor 104 utilizes the OCR to extract the parameters for comparing the first image (e.g., payer's check image) and the second image (payee's check image) of the check, especially in comparing the textual information present on the both checks. For example, at first the OCR is employed to extract textual content from the first image and the second image. Further, the extracted text undergoes preprocessing steps to eliminate noise, standardize formatting, and address inconsistencies that arise during the OCR.

At step S414, the method includes generating, by the at least one processor 104, a check similarity score based on the determined overlap between the first set of parameters and the second set of parameters. In an implementation, the generation of the check similarity score is further based on a result of performing a pixel-by-pixel comparison between the first image of the check and the second image of the check. In an exemplary implementation, the pixel-by-pixel comparison between the first image of the check and the second image of the check is performed to generate the check similarity score in case of failure of the overlapping of the first set of parameters with the second set of parameters.

In an exemplary implementation, the at least one processor 104 performs the pixel-by-pixel comparison between the first image of the check and the second image of the check to generate or compute the check similarity score. As used herein, the pixel-by-pixel comparison corresponds to a technique of comparing two images by examining (e.g., color values, intensity values) each individual pixel at the same location in both images. Further, the at least one processor 104 partitions the first image of the check and the second image of the check in the plurality of fields to identify the image statistics of the first image and second image. Each image (e.g., the first image and the second image) is divided into non-overlapping blocks of pixels, and for every block, statistical measures such as a mean intensity, a standard deviation, and a covariance are computed to capture a local texture and structure of each image. The image statistics calculated for each block in the first image and the second image are compared using a similarity metric. One common similarity metric used is a structural similarity index (SSI), which measures the similarity between the image statistics of the corresponding blocks in the first image and the second image. The similarity measures obtained for each block are aggregated to produce an overall check similarity score for a pair of the first image and the second image. The check similarity score indicates a degree of similarity between the first image and the second image. Based on the overall similarity score, a threshold is applied to determine whether the first image and the second image are considered similar or dissimilar.

At step S416, the method includes determining, by the at least one processor 104, an authenticity of the check based on a comparison of the generated check similarity score with a predefined threshold validity score. The authenticity of the check is determined as a valid check in an event the generated check similarity score is at least equal or greater than the predefined threshold validity score. The authenticity of the check is determined as a fraudulent check in an event the generated check similarity score (hereinafter interchangeably referred to as check similarity score) is less than the predefined threshold validity score.

For example, if the predefined threshold validity score is 90 and the check similarity score is 95, then the check is determined as a valid check. If the predefined threshold validity score is 90 and the check similarity is 80, then the check is determined as a fraudulent check. Further, in case the check similarity score is less than the predefined threshold validity score, then the check may be sent for a manual review by the operation team of the financial institution for further validation.

The method further includes displaying, by the at least one processor via an interface that is accessible by a financial institution, the generated check similarity score and at least one reason associated with the generated check similarity score. In an implementation, the check similarity score is a numerical value or a percentage. The at least one processor provides the at least one reason which is based on attributes that are flagged as unusual (e.g., a change in a check number, a name, a signature, or any other parameters of the check). For example, a representative or a bank official of the financial institution may view this check similarity score and the associated at least one reason on a user interface of the mobile application. The user interface may be configured to highlight the areas where the check deviates from the norm or appears suspicious, providing the financial institution with actionable insights for further review or validation.

Next, the method includes receiving, by the at least one processor, a feedback from the financial institution in response to the displayed check similarity score. The at least one reason may include information related to change in a check number, a name, a signature, or any other parameters of the check. The at least one reason may indicate deletions or modifications in the original parameters of the check.

In an exemplary implementation, the method includes receiving, by the at least one processor 104, the feedback from the bank official in response to at least the displayed check similarity score and the corresponding at least one reason associated with change in at least one of the parameters of the check.

The method further includes providing, by the at least one processor 104, the received feedback to a trained model (hereinafter interchangeably referred to as model) to improve future check evaluations related to the check similarity score.

In an implementation, the feedback is received via an input from the user interface, such as a confirmation or a rejection button or a form where the bank official of the financial institution can input additional comments about the check. For example, the feedback provided by the financial institution may indicate that the check appears authentic and approve the transaction, or the institution may flag the check for further investigation, thus triggering additional verification processes. The feedback may include asking the bank official to provide inputs on the check similarity score (for example, correct score or incorrect score). The feedback received from the bank official gets transferred to the system or the trained model (e.g., an artificial intelligence (AI) based model) for continuous enrichments and learnings. Thus, the bank official may provide the feedback to the system to increase the accuracy while determining the authenticity of the check. The feedback provided by the financial institution is then used to update the model. If the financial institution flags the check as fraudulent, the feedback is incorporated as a positive example of a fraudulent check, allowing the model to refine its understanding of what constitutes fraudulent behaviour. Conversely, if the check is confirmed as authentic, the feedback serves as a positive example of a legitimate check, improving the model's accuracy for future checks. The model uses the feedback to adjust the weights or parameters of its underlying algorithms, thereby enhancing its future predictions and check similarity score generation. This feedback loop creates an iterative process where the model continually improves over time by learning from both human validation and new data.

In an example, the displayed similarity score is 85 due to blurriness in one of the second set of parameters extracted from the second image of the check. The bank official may evaluate that the change in the second set of parameters is due to spread of liquid on the check and not because of the alteration or modification in the second set of parameters associated with the second check.

The method may include storing, by the at least one processor 104, the feedback received from the bank official in response to the displayed check similarity score. The feedback may be further used to provide better recommendation(s) for determining authenticity of the check. This way the present disclosure provides the best possible recommendation(s) in the form of a check similarity score related to legitimacy of the check.

In an exemplary implementation, the method includes generating, by the at least one processor 104, a detailed failure message in case an invalid check is detected. In an exemplary implementation, the at least one processor 104 may transmit a notification over the user interface of the application to notify the user/bank official about the invalid check.

In an exemplary implementation, the notification may be customized to be delivered via various channels, such as email, short message service (SMS), or even as a push notification from the application, depending on the system's capabilities.

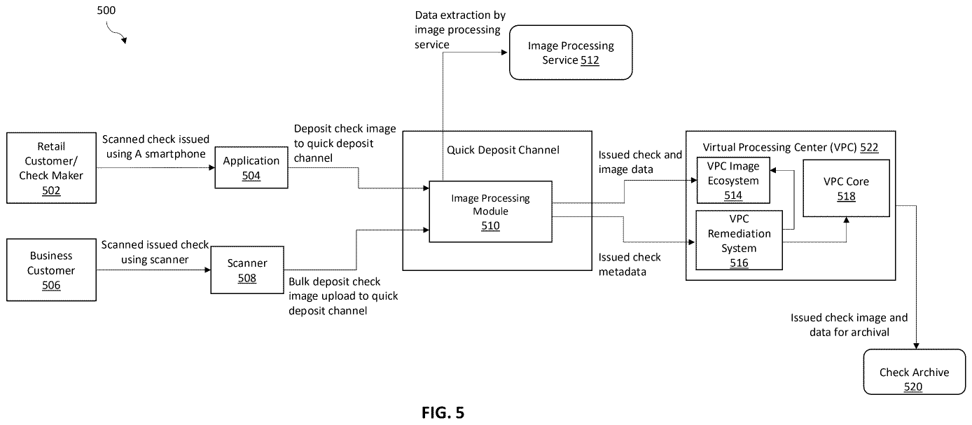

FIG. 5 illustrates a process flow diagram representing a transaction of an issued check, in accordance with an exemplary embodiment. As illustrated in FIG. 5, the process flow 500 begins with receiving a check from a retail customer or a check maker 502. Further, an image of an issued check is scanned and uploaded using an application 504 (e.g., smartphone application). Similarly, a business customer 506 scans an issued check using a scanner 508 (e.g., single scanning and bulk scanning options available at the scanner 508 for multiple checks). Further, the image of the scanned check is transmitted to a quick deposit channel from the application 504 and further received by an image processing module 510. In the event of bulk deposit of the checks that are scanned by the scanner 508, images of such checks are further uploaded to the quick deposit channel and received by the image processing module 510.

At first, an image processing service 512 is employed by the image processing module 510 to extract a textual content (first set of parameters and the second set of parameters) from the received check images (e.g., an image of the check maker's 502 check and an image of the check of the business customer 506) followed by a pixel-by-pixel comparison of the received check images. Further, the extracted text from the check images undergoes preprocessing steps to eliminate noise, standardize formatting, and address inconsistencies. This includes tasks such as removing special characters and ensuring uniformity in text structure. The image processing service 512 is configured to extract a first set of parameters associated with each of said check images. The first set of parameters may include but are not limited to, a name of a payee, a name of an issuing bank, branch details, a magnetic ink character recognition (MICR) code, a date, a signature, a check number, and an amount.

Further, the plurality of parameters and check images (e.g., issued check(s) and an image data) are transmitted to a virtual processing center (VPC) 522, and in particular, to a VPC image ecosystem 514, from the image processing module 510. A metadata of the issued check (or issued checks) is transmitted to a VPC remediation system 516. The VPC remediation system 516 retrieves the check image from the VPC image ecosystem 514 and releases the check for storage purposes to a VPC core 518. It is to be noted that the VPC 522 includes the VPC remediation system 516, the VPC image ecosystem 514, and the VPC core 518. Further, the image of the issued check (or issued checks) and the image data is transmitted to a check archive 520. The check archive 520 stores the issued checks and images of such issued checks that may be retrieved for determining check fraud by using an artificial intelligence (AI)/machine learning (ML) based model. In an exemplary embodiment, when the system needs to determine whether a check is fraudulent, the check archive 520 provides access to both historical data and the check images. These checks are retrieved for further processing and analysis. The AI model then uses the historical check data and the check images to assess the likelihood of fraud by comparing features of the retrieved checks with known patterns of fraudulent activity, learned from the historical data and the check images. The AI model helps to identify checks that may have been altered, forged, or otherwise manipulated, providing an automated and accurate means of fraud detection. For example, the AI model receives a feedback provided from a financial institution. If the financial institution flags the check as fraudulent, the feedback is incorporated as a positive example of a fraudulent check, allowing the AI model to refine its understanding of what constitutes fraudulent behaviour. Conversely, if the check is confirmed as authentic, the feedback serves as a positive example of a legitimate check, improving the AI model's accuracy for future checks. The AI model uses the feedback to adjust the weights or parameters of its underlying algorithms, thereby enhancing its future predictions and check similarity score generation.

It will be appreciated by the person skilled in the art that the disclosed method offers a full-circle, adaptable, and intelligent solution for implementing a method to determine an authenticity of a check and prevent fraudulent financial transactions. The present disclosure uses a plurality of image processing techniques and models to determine the authenticity of the check. The plurality of image processing techniques and models includes but are not limited to feature extraction techniques, pixel comparison techniques, machine learning models for anomaly detection, deep learning techniques, texture analysis, signature verification techniques, security feature analysis model, pattern recognition model, image post processing model, image forgery detection techniques, image quality assessment model, semantic segmentation techniques, OCR, and text analysis techniques.

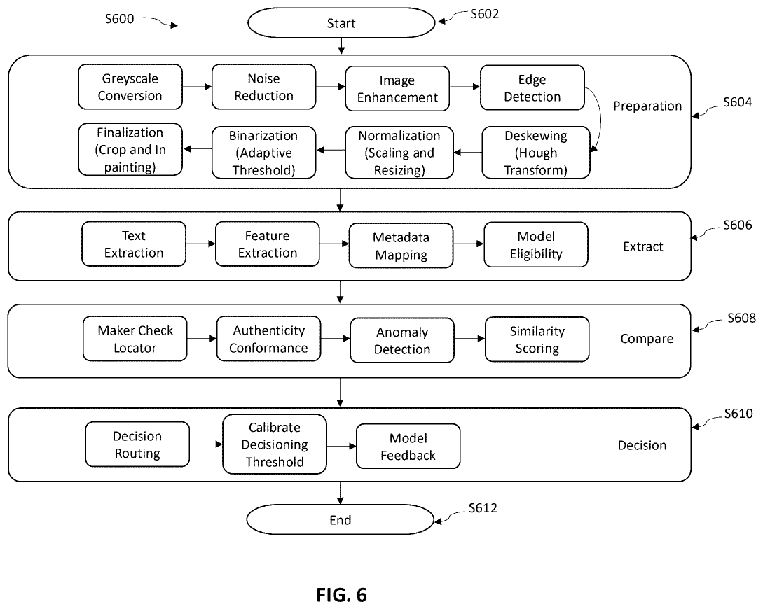

FIG. 6 illustrates a process flow diagram representing an image analysis process of a check image, in accordance with an exemplary embodiment of the present disclosure.

As illustrated in FIG. 6, the process flow S600 begins at step S602. At step S604, the image analysis process begins with a preparation of text preprocessing of an image of a bank check (e.g., a payer's check/a deposited check). In an exemplary implementation, the image analysis process is performed by at least one processor 104 using an image processing module 510. At first, a greyscale conversion action occurs on the image of the check. The greyscale conversion converts a red-green-blue (RGB) color image of the bank check (e.g., a first image of the bank check and a second image of the bank check) into a greyscale image. This simplifies processing since an optical character recognition (OCR) algorithm (also referred to as OCR) typically works with greyscale images. Further, a noise reduction is applied over the greyscale image of the bank check with techniques like a median filtering, which are applied to reduce noise while preserving important details of the image. Further, an image enhancement (e.g., contrast limited adaptive histogram equalization (CLAHE)) is performed over the greyscale image to improve contrast and sharpen edges and make text more distinguishable from a background. Further, an edge detection is performed over the greyscale image to identify the boundaries of characters and other elements present on the greyscale image of the bank check. It is to be noted that bank checks are frequently scanned or photographed at angles, resulting in skewed images. Deskewing is applied over the greyscale image to correct the tilt in the image, ensuring that text lines are horizontal and vertical which helps accurately interpret and recognize characters. Further, a normalization of the greyscale image of the check involves resizing of the greyscale image to a standard dimension suitable for processing using the OCR. This step ensures consistent text size and spacing, improving the OCR accuracy across different sized checks. Further, a binarization converts the greyscale image of the bank check into a binary image where text appears black, and the background appears white. The adaptive thresholding techniques are particularly useful for bank checks to handle variations in lighting, paper quality, and background colors effectively. Thereafter, at a finalization step, the greyscale image is cropped to remove unnecessary borders or artifacts that could interfere with the OCR processing. Additionally, inpainting techniques may be used to fill in any remaining gaps or holes in the image after cropping, ensuring that all text is clear and readable by the OCR.

After preprocessing the image of the bank check, the next stage involves extracting meaningful text from the processed greyscale image (also referred to as preprocessed image). At step S606, the OCR is configured to extract textual information from the pre-processed image of the check (e.g., the first image of the check and/or the second image of the check). Further, a feature extraction is performed over the preprocessed image. The feature extraction involves identifying and capturing specific attributes or characteristics from the extracted text or image. Further, in a metadata mapping, mapping to an extracted information or text to predefined metadata fields is performed. Thereafter, determining a model eligibility of the check based on the extracted information is critical for compliance and operational efficiency in banking.

At step S608, the at least one processor 104 compares the extracted text from both images of the check (e.g., the first image of the check and the second image of the check) to identify similarities and differences or modifications. The comparison may be performed by using various text comparison algorithms such as a Levenshtein distance, a cosine similarity, or a Jaccard similarity, to compute a similarity score (or a validation score). Further, the computation or generation of the check similarity score is further based on a result of performing a pixel-by-pixel comparison between the first image of the check and the second image of the check. The similarity score is assigned to the check to quantify the degree of similarity between the two images of the check and determine authenticity of the check. At step S610, based on the similarity score, a threshold is applied to determine whether the two images are considered similar or dissimilar, for the decision routing. At last, the at least one processor 104 may receive feedback from bank officials in response to the similarity score. The at least one processor 104 may save the feedback in a database to enhance a training dataset for the OCR processing and pixel-by-pixel comparison. The process ends at step S612.

The present disclosure provides numerous advantages as given below. The present disclosure provides a method for detecting check fraud and determining an authenticity of a check. The check fraud detection method helps in preventing financial losses caused due to fraudulent activities such as counterfeit checks, forged signatures, or altered amounts. The present disclosure successfully reduces manual efforts required in the validation process of deposited checks. The present disclosure reduces deposit hold time by ensuring faster and more accurate validation of a deposited check and a payer's check. The method disclosed in the present disclosure can efficiently process large volumes of checks, identifying suspicious patterns or anomalies quickly and accurately. This reduces the need for manual review and speeds up the transaction processing. Existing solutions fall short in empowering customers to proactively notify banks about the issued checks, leaving the customers vulnerable to the ever-evolving tactics of fraudsters. As the checks are altered through water washing, tampering and other deceitful means, the customers and banks suffer substantial financial losses. Banks often struggle to alert the customers in time, allowing fraud to go unchecked. The solution offered by the present disclosure safeguard the customers and banks from financial ruin by proactively determining the authenticity of the check.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to determine an authenticity of a check is disclosed. The instructions include executable code which, when executed by a processor 104, may cause the processor 104 to receive a first image of a check; extract a first set of parameters associated with the first image of the check; store the first set of parameters in a database; receive a second image of the check subsequent to a deposit of the check, via at least one deposit channel; extract a second set of parameters associated with the second image of the check; compare the first set of parameters with the second set of parameters to determine an overlapping of the first set of parameters with the second set of parameters; generate a check similarity score based on the overlapping of the first set of parameters with the second set of parameters; and determine an authenticity of the check based on a comparison of the generated check similarity score with a predefined threshold validity score.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for determining an authenticity of a check, the method being implemented by at least one processor, the method comprising:
receiving, by the at least one processor, a first image of a check;
extracting, by the at least one processor, a first set of parameters associated with the first image of the check;
storing, by the at least one processor, the first set of parameters in a database;
receiving, by the at least one processor, a second image of the check subsequent to a deposit of the check, via at least one deposit channel;
extracting, by the at least one processor, a second set of parameters associated with the second image of the check;
comparing, by the at least one processor, the first set of parameters with the second set of parameters to determine an overlap between the first set of parameters and the second set of parameters;
generating, by the at least one processor, a check similarity score based on the determined overlap between the first set of parameters and the second set of parameters; and
determining, by the at least one processor, an authenticity of the check based on a comparison of the generated check similarity score with a predefined threshold validity score.

2. The method as claimed in claim 1, wherein the first image of the check is received from a payer of the check and the second image of the check is received from a financial institution associated with processing of the deposited check.

3. The method as claimed in claim 1, wherein the first set of parameters is extracted by applying at least one image processing algorithm to the first image of the check, and wherein the second set of parameters is extracted by applying the at least one image processing algorithm to the second image of the check.

4. The method as claimed in claim 1, wherein each of the first set of parameters and the second set of parameters comprises at least one from among a name of a payer, a name of a payee, a name of an issuing bank, branch details, an account number of the payer, a magnetic ink character recognition (MICR) code, a date, a signature, a check number, and an amount.

5. The method as claimed in claim 1, wherein the generating of the check similarity score is further based on a result of a pixel-by-pixel comparison between the first image of the check and the second image of the check.

6. The method as claimed in claim 1, wherein the authenticity of the check is determined as a valid check in an event the generated check similarity score is at least equal or greater than the predefined threshold validity score.

7. The method as claimed in claim 1, wherein the authenticity of the check is determined as a fraudulent check in an event the generated check similarity score is less than the predefined threshold validity score.

8. The method as claimed in claim 1, further comprising:
displaying, by the at least one processor via an interface that is accessible by a financial institution, the generated check similarity score and at least one reason associated with the generated check similarity score; and
receiving, by the at least one processor, a feedback from the financial institution in response to the displayed check similarity score.

9. The method as claimed in claim 8, further comprising providing, by the at least one processor, the received feedback to a trained model to improve future check evaluations related to the check similarity score.

10. A computing device configured to determine an authenticity of a check, the computing device comprising:
a processor;
a memory; and
a communication interface coupled to each of the processor and the memory,
wherein the processor is configured to:
receive a first image of a check;
extract a first set of parameters associated with the first image of the check;
store the first set of parameters in a database;
receive a second image of the check subsequent to a deposit of the check, via at least one deposit channel;
extract a second set of parameters associated with the second image of the check;
compare the first set of parameters with the second set of parameters to determine an overlap between the first set of parameters and the second set of parameters;
generate a check similarity score based on the determined overlap between the first set of parameters and the second set of parameters; and
determine an authenticity of the check based on a comparison of the generated check similarity score with a predefined threshold validity score.

11. The computing device as claimed in claim 10, wherein the first image of the check is received from a payer of the check, and the second image of the check is received from a financial institution associated with processing of the deposited check.

12. The computing device as claimed in claim 10, wherein the first set of parameters is extracted by applying at least one image processing algorithm to the first image of the check, and wherein the second set of parameters is extracted by applying the at least one image processing algorithm to the second image of the check.

13. The computing device as claimed in claim 10, wherein each of the first set of parameters and the second set of parameters comprises at least one from among a name of a payer, a name of a payee, a name of an issuing bank, branch details, an account number of the payer, a magnetic ink character recognition (MICR) code, a date, a signature, a check number, and an amount.

14. The computing device as claimed in claim 10, wherein the generation of the check similarity score is further based on a result of a pixel-by-pixel comparison between the first image of the check and the second image of the check.

15. The computing device as claimed in claim 10, wherein the authenticity of the check is determined as a valid check in an event the generated check similarity score is at least equal or greater than the predefined threshold validity score.

16. The computing device as claimed in claim 10, wherein the authenticity of the check is determined as a fraudulent check in an event the generated check similarity score is less than the predefined threshold validity score.

17. The computing device as claimed in claim 10, wherein the processor is further configured to:
display, via an interface that is accessible by a financial institution, the generated check similarity score and at least one reason associated with the generated check similarity score; and
receive a feedback from the financial institution in response to the displayed check similarity score.

18. The computing device as claimed in claim 17, wherein the processor is further configured to provide the received feedback to a trained model to improve future check evaluations related to the check similarity score.

19. A non-transitory computer readable storage medium storing instructions to determine an authenticity of a check, the storage medium comprising executable code which, when executed by a processor, causes the processor to:
receive a first image of a check;
extract a first set of parameters associated with the first image of the check;
store the first set of parameters in a database;
receive a second image of the check subsequent to a deposit of the check, via at least one deposit channel;
extract a second set of parameters associated with the second image of the check;
compare the first set of parameters with the second set of parameters to determine an overlap between the first set of parameters and the second set of parameters;
generate a check similarity score based on the determined overlap between the first set of parameters and the second set of parameters; and
determine an authenticity of the check based on a comparison of the generated check similarity score with a predefined threshold validity score.

20. The storage medium as claimed in claim 19, wherein the first set of parameters is extracted by applying at least one image processing algorithm to the first image of the check, and wherein the second set of parameters is extracted by applying the at least one image processing algorithm to the second image of the check.
